(19) United States
(12) Patent Application Publication
(10) Pub. No.: US 2022/0085651 A1
(43) Pub. Date: Mar. 17, 2022

(54) LOW-LOSS VOLTAGE REGULATOR FOR WIRELESS-CHARGING RECEIVERS

(71) Applicant: POWERMAT TECHNOLOGIES LTD., Petach Tikva (IL)

(72) Inventors: Itay SHERMAN, Hod HaSharon (IL); Amir SALHUV, Nes Ziona (IL); Elieser MACH, Rosh Tzurim (IL)

(73) Assignee: POWERMAT TECHNOLOGIES LTD., Petach Tikva (IL)

(21) Appl. No.: 17/420,415

(22) PCT Filed: Jan. 9, 2020
(86) PCT No.: PCT/IB2020/050155

§ 371 Date: Jul. 2, 2021

Related U.S. Application Data
(60) Provisional application No. 62/790,564, filed on Jan. 10, 2019.

(51) Int. Cl. H02J 50/12; H02J 50/80; H02J 7/02

(52) U.S. Cl. CPC H02J 50/12; H02J 7/02; H02J 50/80

(57) ABSTRACT

A voltage regulator for regulating power obtained from a bridge of a receiver for powering a load, wherein the receiver is wirelessly charged by a transmitter, the regulator comprising: a plurality of capacitors connected to each other in series and parallel to a rectified voltage of the bridge; one selector per one capacitor of the plurality of capacitors for engaging the one capacitor to the load; and a controller comprising: one selecting signal per the one selector configured to either engage or disengage the one capacitor to or from the load; and at least one sensor for current and voltage measurements.

### CROSS-REFERENCE TO RELATED APPLICATION

This application claims priority under 35 U.S.C. § 119(e) from co-pending; U.S. Provisional Patent Application No. 62/790,564 by Itay Sherman, Amir Salhuv and Elieser Mach titled “Low Loss Receiver Design”, filed on Jan. 10, 2018, which is incorporated in its entirely by reference for all purposes.

### TECHNICAL FIELD

The present disclosed subject matter relates to wireless power charging receivers. More particularly, the present disclosed subject matter relates to novel design of regulating power obtained by a receiver.

### BACKGROUND

Growing demand for wireless power charging systems, led to dramatic deployments increase, in a wide variety of venues, raises the need for increasing the effective charging distance between a transmitter and a receiver.

The power section (stage) of wireless power receivers typically utilize a full or half wave rectification circuit (bridge) among other rectification techniques followed by a voltage/current stabilizing circuit (regulator).

Commercially available regulators typically use technologies such as low-dropout (LDA) or DC-to-DC buck converter, for implementing the regulator. In many implementations low-dropout regulator is preferred over a buck converter or other DC-to-DC converters or vice versa.

Low-dropout regulator technology requires that the rectified voltage, coming from the bridge, should be set slightly higher than the desired output voltage of the regulator. Due to thermal considerations of the low-dropout regulators, i.e. linear voltage regulator, the rectified voltage at the input of the LDA regulator wouldn't be set significantly higher than the desired output voltage.

This is pointing toward relatively high current in the receiving coil capable of generating rectified voltage that can supply relevant power demands, for example up to 10 W at a 9V output. This drawback is due to receiving coils, typically used in devices, that have considerable AC resistance (typically>300 mΩ) causing a significant amount of power loss on the receiving coil.

On the other hand, DC-to-DC converters can operate the rectifier in higher voltages to reduce current on reception coil, however, the DC-to-DC design requires an inductor for its operation for sustaining high output currents. The required inductor has significant AC and DC resistances, which contributes power loss.

### BRIEF SUMMARY

According to a first aspect of the present disclosed subject matter a voltage regulator for regulating power obtained from a bridge of a receiver for powering a load, the regulator comprising: a plurality of capacitors connected to each other in series and parallel to a rectified voltage of the bridge; one selector per one capacitor of the plurality of capacitors for engaging the one capacitor to the load; and a controller comprising: one selecting signal per the one selector configured to either engage or disengage the one capacitor to or from the load; and at least one sensor for current and voltage measurements.

In some exemplary embodiments, the receiver is wirelessly charged by a transmitter.

In some exemplary embodiments, the receiver is integrated within a device and wherein the load is selected from a group consisting of: a battery of a device; the device; and a combination thereof.

In some exemplary embodiments, the bridge is selected from a group consisting of a full wave rectification circuit; a half wave rectification circuit; and a combination thereof.

In some exemplary embodiments, the selector is comprised of at least two N-channel Metal Oxide Semiconductor Field Effect Transistor (N-MOS FETs).

In some exemplary embodiments, the selecting signal is configured to control a gate of the at least two N-MOS FETs in order to engage or disengage the one capacitor to or from the load.

In some exemplary embodiments, the engaging the one capacitor to the load is done, by the selector, for both ends of the capacitor discretely yet concurrently.

In some exemplary embodiments, voltage across each capacitor of the plurality of capacitors is identical and wherein each capacitor is engaged, by the controller, to the load until voltage measured across the load, by the at least one sensor, drops below a minimum threshold value.

In some exemplary embodiments, the controller is configured to calculate and set the threshold based on measurements of the rectified voltage and voltage across the load using the at least one sensor.

In some exemplary embodiments, the regulator further comprises dedicated circuit utilized by the controller for continues or periodic current measurements trough the one capacitor.

In some exemplary embodiments, the controller prevents the plurality of capacitors from engaging to the load for a deadtime occurring between disengaging a capacitor and engaging another capacitor.

In some exemplary embodiments, the controller utilizes a predetermined switching frequency for engaging and disengaging each capacitor of the plurality of capacitors.

In some exemplary embodiments, voltage across each capacitor of the plurality of capacitors is identical and wherein at least two capacitors are engaged, by the controller, to the load until voltage measured across the load by the sensor drops below a minimum threshold value.

In some exemplary embodiments, the controller communicates a request to the transmitter to adjust its transmitted power level to satisfy a desired rectified voltage level.

In some exemplary embodiments, the regulator further comprises at least one additional selector and at least one resistor configured for measuring a voltage drop on the one selector for determining, by the controller, a calibration ratio.

In some exemplary embodiments, the controller determines the calibration ratio based on the selector resistance obtained by measuring voltage across the selector and calculating current flowing through the selector.

Unless otherwise defined, all technical and scientific terms used herein have the same meaning as commonly understood by one of ordinary skill in the art to which this disclosed subject matter belongs. Although methods and materials similar or equivalent to those described herein can be used in the practice or testing of the present disclosed subject matter, suitable methods and materials are described below. In case of conflict, the specification, including definitions, will control. In addition, the materials, methods, and examples are illustrative only and not intended to be limiting.

### BRIEF DESCRIPTION OF THE DRAWING

Some embodiments of the disclosed subject matter described, by way of example only, with reference to the accompanying drawings. With specific reference now to the drawings in detail, it is stressed that the particulars shown are by way of example and for purposes of illustrative discussion of the preferred embodiments of the present disclosed subject matter only, and are presented in the cause of providing what is believed to be the most useful and readily understood description of the principles and conceptual aspects of the disclosed subject matter. In this regard, no attempt is made to show structural details of the disclosed subject matter in more detail than is necessary for a fundamental understanding of the disclosed subject matter, the description taken with the drawings making apparent to those skilled in the art how the several forms of the disclosed subject matter may be embodied in practice.

In the drawings:

FIG. 1 illustrates a block diagram of a wireless power receiver and a principle schematic of a regulator, in accordance with some exemplary embodiments of the disclosed subject matter.

### DETAILED DESCRIPTION

Before explaining at least one embodiment of the disclosed subject matter in detail, it is to be understood that the disclosed subject matter is not limited in its application to the details of construction and the arrangement of the components set forth in the following description or illustrated in the drawings. The disclosed subject matter is capable of other embodiments or of being practiced or carried out in various ways. Also, it is to be understood that the phraseology and terminology employed herein is for the purpose of description and should not be regarded as limiting. The drawings are generally not to scale. For clarity, non-essential elements were omitted from some of the drawings.

The terms “comprises”, “comprising”, “includes”, “including”, and “having” together with their conjugates mean “including but not limited to”. The term “consisting of” has the same meaning as “including and limited to”.

The term “consisting essentially of” means that the composition, method or structure may include additional ingredients, steps and/or parts, but only if the additional ingredients, steps and/or parts do not materially alter the basic and novel characteristics of the claimed composition, method or structure.

As used herein, the singular form “a”, “an” and “the” include plural references unless the context clearly dictates otherwise. For example, the term “a compound” or “at least one compound” may include a plurality of compounds, including mixtures thereof.

Throughout this application, various embodiments of this disclosed subject matter may be presented in a range format. It should be understood that the description in range format is merely for convenience and brevity and should not be construed as an inflexible limitation on the scope of the disclosed subject matter. Accordingly, the description of a range should be considered to have specifically disclosed all the possible sub-ranges as well as individual numerical values within that range.

It is appreciated that certain features of the disclosed subject matter, which are, for clarity, described in the context of separate embodiments, may also be provided in combination in a single embodiment. Conversely, various features of the disclosed subject matter, which are, for brevity, described in the context of a single embodiment, may also be provided separately or in any suitable sub-combination or as suitable in any other described embodiment of the disclosed subject matter. Certain features described in the context of various embodiments are not to be considered essential features of those embodiments, unless the embodiment is inoperative without those elements.

One technical challenge dealt with by the disclosed subject matter is reducing the wireless power receiver form-factor by eliminating an inductor for sustaining high output currents.

Another technical challenge dealt with by the disclosed subject matter is power loss wasted on heat, i.e. low efficiency, resulting from a significant AC and DC resistances of such inductors.

Yet another technical challenge dealt with by the disclosed subject matter is a significant amount of power loss on the receiver's coil when the rectified voltage is relatively close to voltage required by a load, i.e. power source or battery of a receiver of a chargeable device.

In view of the technical challenges listed above, it is an objective of the present disclosure to reduce the form-factor of the receiver by eliminating the inductor as well as improving power transfer efficiency and minimizing over heating the receiver.

A preferred technical solution of the present disclosure is utilizing a plurality (N) of capacitors as discrete voltage dividing circuit for implementing an innovative regulating stage. It should be noted that an output voltage (V_{rect}) of a rectification stage (bridge) is an input to the innovative regulating stage (regulator) and an output voltage (V_{reg}) of the regulator is used for powering the load, i.e. charging a power source (battery) of a device that host the receiver or to supplying the device power. The device can be, for example, a smartphone, a laptop, a watch, or the like that host an inductive power receiver.

In some exemplary embodiments, current from the bridge flows through all N identical capacitors and charges them while no load is applied to the capacitors, thus each capacitor will eventually be charged to V_{rect}/N where V_{rect} is the maximal voltage of the bridge. Additionally, or alternatively, the regulator comprises selectors (one selector per capacitor) configured to connect any one of the N capacitors to the output of the regulator for powering the load.

Upon selecting and connecting, i.e. engaging, a specific capacitor to the load, the specific capacitor starts discharging to the load (battery) while it is still being charged from the rectification stage. Gradually, the overall voltage over the capacitor would decrease if the current level to the load is higher than the charging current from the rectification stage. Subsequently, after the voltage across the specific capacitor drops below a threshold, its dedicated selector disconnects the specific capacitor from the load, and connects another capacitor to the load. Then, the capacitor that was disconnected would now be set for recharging.

In some exemplary embodiments, a process of sequentially engaging each capacitor out of the plurality (N) of capacitors to the load is repeated.

One technical effect of utilizing the voltage dividing circuit of the present disclosure is eliminating the need for inductor aimed at sustaining high output currents, thus reducing the form-factor.

Another technical effect of utilizing the voltage dividing circuit of the present disclosure is taking advantage of the fact that the relative ground node of the load is a floating ground defined only relative to the positive voltage of any one of the capacitors. This way, only selected capacitors are connected to both nodes of the load, thus the load is kept to the desired level, while the rectified voltage V_{rect}/N is higher than V_{reg}, however no power is wasted on heat, i.e. better efficiency.

Another technical effect of utilizing the voltage dividing circuit of the present disclosure is the ability to control the threshold voltage for selection stage, thus allowing for regulating specific ripple of the charging current.

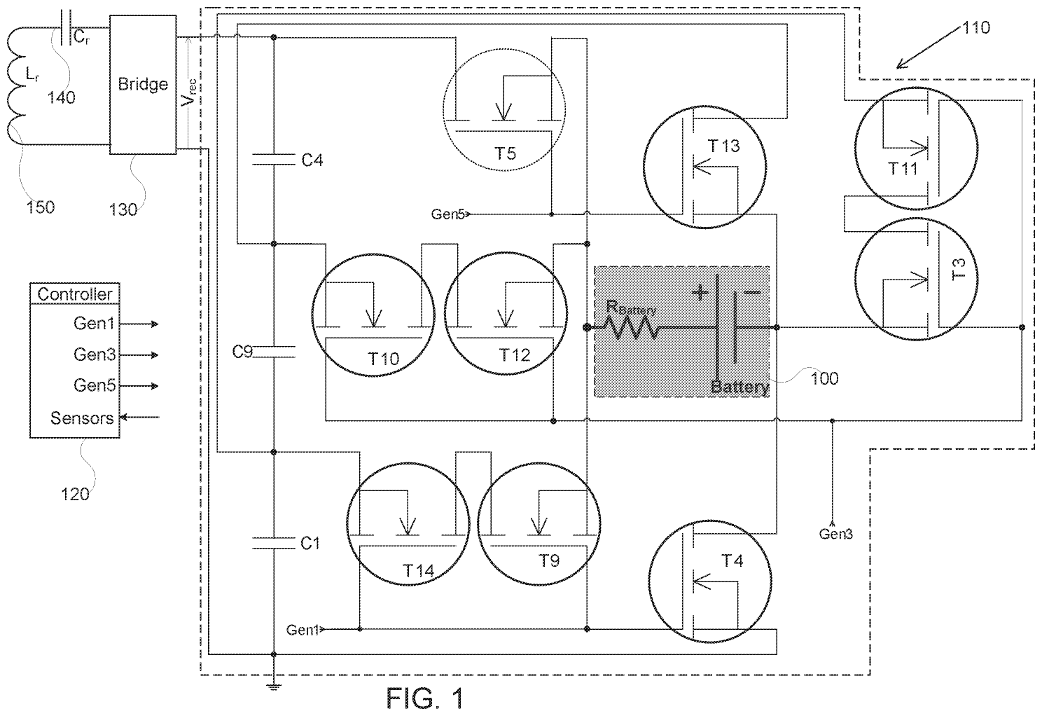

Referring now to FIG. 1 showing a block diagram of a wireless power receiver comprised of a receiver coil (Lr) 150 coupled with a capacitor 140; a bridge 130; a regulator 110 and a controller 120 equipped with selecting and sensing signals; in accordance with some exemplary embodiments of the disclosed subject matter.

In some exemplary embodiments, the Lr150 is an inductive coil, coupled with a resonance capacitor 140, designed to drive bridge 130 with power induced to it by a transmitter coil (not shown). The bridge 130 can be based on a full or half wave rectification circuit for suppling regulator 110 with voltage V_{rect}, that is regulated to output voltage V_{reg} for powering load 100.

In some exemplary embodiments, load 100 can be a power source (battery) of a device, such as a smartphone, a laptop, a watch, or the like that host an inductive power receiver.

In some exemplary embodiments, controller 120 can be based on either a special purpose control circuit or utilizing the native processor of the device that incorporates the receiver. Either way, the controller 120 also comprises a plurality of selecting signals, such as Gen1, Gen3 and Gen5; and at least one sensor used for current and voltage measurements.

In some exemplary embodiments, controller 120 can be a central processing unit (CPU), a microprocessor, an electronic circuit, an integrated circuit (IC), or the like. Additionally, or alternatively, controller 120 can be implemented as firmware written for or ported to a specific processor such as digital signal processor (DSP) or microcontrollers, or can be implemented as hardware or configurable hardware such as field programmable gate array (FPGA) or application specific integrated circuit (ASIC). In some exemplary embodiments, controller 120 can be utilized to perform computations required by receiver or any of its subcomponents.

In some exemplary embodiments of the disclosed subject matter, the controller 120 utilizes its sensors for measuring the following: current flowing through load 100; voltage across the load; voltage across an engaging circuit of regulator 110; voltage across each capacitor of the engaging circuit; voltage across a shunt resistor; and any combination thereof, or the like. Additionally, or alternatively, controller 120 has the capability of governing the selectors that are part of the engaging circuit with selecting signals, such as Gen1, Gen3 and Gen5.

In some exemplary embodiments, controller 120 comprises a semiconductor memory component (not shown). The memory can be persistent or volatile memory, such as for example, a flash memory, a random-access memory (RAM), a programmable read only memory (PROM), a re-programmable memory (FLASH), and any combination thereof, or the like. In some exemplary embodiments, the memory can be configured to retain monitoring information, configuration and control information and application associated with charging management of the receiver.

Additionally, or alternatively, the memory of controller 120 retains instructions and code adapted to cause the controller 120 to execute steps for governing the engaging circuit and connectivity software for communicating with a wireless transmitter (not shown). The connectivity software can be based on protocols that comply with wireless power standards, such as power matters alliance (PMA); wireless power consortium (WPC) and AirFuel Alliance. According to the communication methods described in these standards, but not limited to, the controller 120 can communicate power requirements with the transmitter.

In some exemplary embodiments of the disclosed subject matter, the regulator 110 is comprised of three identical voltage dividing capacitors, C1, C9 and C4 and the engaging circuit designed for selecting and connecting at least one of the dividing capacitors to the load.

It will be appreciated that the dividing capacitors don't have to be identical. In such case, the voltage across each capacitor will be proportional to its value with respect to the rest of the capacitors.

The selectors of the engaging circuit can be implemented with nine (preferred but not limited to) N-channel Metal Oxide Semiconductor Field Effect Transistor (N-MOS FETs) T3, T4, T5, T9, T10, T11, T12, T13 and T14 that are used in the present disclosure as switching transistors. It should be noted that, the design of the engaging circuit is not limited to utilizing the components set forth in FIG. 1. Other semiconductor or switches designs can be used for implementing the engaging circuit for performing the described below operation.

In some exemplary embodiments of the disclosed subject matter, the transistors are set in the engaging circuit for selecting and connecting one dividing capacitor, out of a plurality of capacitors (N), at a time to the load. In the embodiment depicted in FIG. 1 N=3, thus there three possible engagements: 1^{st} engagement connects C1 to load 100; 2^{nd} engagement connects C9 to load 100; and 3^{rd} engagement connects C4 to load 100.

Transistors T4, T9 and T14 are used for the first selector; transistors T3, T10, T11 and T12 are used for the second selector; and transistors T5 and T13 are used for the third selector. Whereas, selecting signals Gen1, Gen3 and Gen5 control the gates the first engagement transistors, the second engagement transistors and the third engagement transistors respectively.

In some exemplary embodiments, T5 connects the positive end of C4 to the positive node of the load while T13 connects the negative end of C4 to the negative node of the load; T10 and T12 connects the positive end of C9 to the positive node of the load while T3 and T11 connects the negative end of C9 to the negative node of the load; and T9 and T14 connects the positive end of C1 to the positive node of the load while T4 connects the negative end of C1 to the negative node of the load.

It should be noted that the following pairs of N-MOS FET transistors: T3 with T11; T9 with T14; and T10 with T12 are connected back to back so that their body diode are connected in reverse direction to one another in order to prevent undesired conductance via the body diodes of the transistors when a specific selection transistors are not activated.

In some exemplary embodiments, the selecting signals Gen1, Gen3 and Gen5, connected to the gates of the transistors, are generated by controller 120 to sequentially activate the appropriate engagement transistors. The controller inserts dead periods between each engagement, were none of the capacitors is connected to the load in order to avoid shorts on the capacitors or load. It will be reminded that, signals Gen1,3 &5 control the transistors to enable connection of one of the capacitors to the battery at a time.

In some exemplary embodiments, a, controller generated, sequence for connecting each capacitor to charge the load, e.g. first C4 followed by C9 then C1 and repeat, can be either predetermined; determined in real time; and any combination thereof, or the like.

In predetermined sequence, fixed time intervals can be set for each connection including dead periods, i.e. no capacitor is connected to the load. In this exemplary embodiment, the predetermined sequence yields a specific switching frequency that can be obtained based on past average measurements. However, this approach, requires good matching between the capacitors to ensure that all phases of charging sequence have similar currents and ripple levels.

In an alternative exemplary embodiment, the sequence can be determined in real time by measurements and calculations that define a minimum threshold voltage that allows for minimal necessary charging current. When the voltage on the load drops below the minimum threshold, the selected capacitor is disconnected from the load by disabling the selecting signal that engaged that capacitor. Thereby, the length of time that each capacitor was connected to the load plus the dead time constituted a cycle of the switching frequency, i.e. real time determined sequence.

In some exemplary embodiments, the threshold voltage is calculated as follows: V_{bat}+Iₘᵢₙ*R_{bat} were V_{bat} is the voltage of load 100 (when it is not charged); R_{bat} is the load (battery) internal resistance and Iₘᵢₙ the minimal necessary charging current.

For example, a battery designed to be charged to 3.9V having an internal resistance of 0.08Ω and 0.02Ω equivalent series resistance (ESR) of a selected capacitor and it associated transistor. The battery is set to be charged at 4 Amps (A) having current ripple of 2 A Peak to Peak. Based on the above battery data, the lower current level would be 3 A, thus the minimal threshold voltage should be 3.9V+(0.08Ω+0.02Ω)*3 A=4.2V. Accordingly, the charged voltage of the capacitor should be 3.9V+(0.08Ω+0.02Ω)*5 A=4.4V, therefore the Vᵥᵣₜ for a 3 capacitor design, should be 4.4V*2+4.2V=13V.

In some exemplary embodiments, V_{bat} can be measured by controller 120 on the dead time intervals between capacitors switching, when no capacitor is connected to the battery, whereas R_{bat} can be calculated based on measurements, by controller 120, of the current flowing through the battery and the overall battery voltage at that time. The current measurement can be performed continually or at specific intervals and on specific capacitor connection using dedicated circuit (not shown), such as measuring voltage across a shunt resistor.

Additionally, or alternatively, the engagement circuit can be configured to connect more than one capacitor in series to the load. Such connection can be used to allow charging when rectified voltage is not sufficiently high to allow the division by N. As an example, given the above circuit, if Vᵥᵣₜ cannot reach the 13V level, the engagement circuit connects the load to the positive end of C9 and the negative end of C1 to provide voltage equal to 2/3Vᵥᵣₜ that allows operation when the bridge voltage Vᵥᵣₜ is approximately 6.5V. Consequently, the controller can also connect capacitors C9 and C4 as well as C1 and C4, in rotation, to the load.

In some exemplary embodiments of the disclosed subject matter, the receiver is configured to provide feedback, to the transmitter, designated to adjust the transmitted power level to the desired Vᵥᵣₜ level to satisfy the required charging current and/or voltage. The communication between the transmitter and the receiver for communicating digital feedback signals can be supported by standards such as WPC, allowing updates in cycles of a few tenth of milliseconds.

It should be noted that fast switch of the receiver or sudden movement of the receiver on a charging surface can cause the voltage of the capacitors Vᵥᵣₜ to either increase or decrease rapidly. The effect of Vᵥᵣₜ drop can cause a tolerable short interruption of charging, however, a sudden increase of Vᵥᵣₜ can damage the battery, when any of the capacitors is connected to it. This problem can be resolved on the transmitter (Tx) end, at the receiver (Rx) end, or both.

In one exemplary embodiment, Tx can sense a reflected impedance of the receiver by measuring current value and phase of the Tx primary coil, calculating the overall impedance and then reducing the Tx own impedance to derive the Rx impedance. This way, the change in the reflected impedance can be sensed at time constants much shorter than the digital feedback method can provide. At that point, the Tx can reduce the transmitted power and avoid significant Vᵥᵣₜ increase. This immediate defensive step can reduce the Vᵥᵣₜ of the receiver to levels that do not allow charging, however it can be corrected later on based on the digital feedback provided by the receiver.

In another exemplary embodiment, the Rx can be configured to disconnect the capacitors from the load if the Vᵥᵣₜ level increases above a desired threshold value, or if measured current flowing to the load or voltage measured across the load exceed a predetermined threshold while any capacitor is connected to the load. In such case, a dummy load is used to enable capacitors discharge. Additionally, or alternatively, a detune capacitor can be used to decrease the rectified voltage. The detune capacitor can be connected in parallel to the rectifier bridge or in parallel to the resonance capacitor. The detune capacitor can be switched on if Vᵥᵣₜ goes above a defined threshold and disconnected once the voltage decreases below a certain threshold.

It will be noted that the charging current measurement is performed by measuring the voltage across the transistors of the engaging circuit for eliminating a need of shunt resistors for current measurement. Yet, the resistance of the transistors is a) not necessarily known; b) temperature dependent; and c) gate voltage dependent, hence a calibration process is used.

In some exemplary embodiments of the disclosed subject matter, regulator 110 comprises a calibration circuit (not shown) consists of additional N-MOS FET (calibration transistor) connected in series to a resistor that its other end is connected to ground and the other end of the calibration transistor is connected to one of the back to back transistors, e.g. T10. The calibration process is performed by enabling T10 and the calibration transistor, while disabling the other. Consequently, current will flow through T10, the calibration transistor and the resistor facilitates measuring (by controller 120) the voltage drop on the resistor and the voltage drop on T10. Thereby, a ratio between the measured voltage on the resistor and T10 shall be used as will be the ratio of resistances, i.e. calibration ratio.

Additionally, or alternatively, the calibration process comprises measuring voltage on two sides of the transistor at least twice or more on known intervals. The voltage on the side connected to the capacitor will decay exponentially and the current flowing through the transistor will also have an exponential decay with same decay factor as the voltage. From the decay factor and known capacitor capacitance, the current flowing through the transistor can be calculated. Dividing the voltage drop on the transistor (the difference in voltage on its two sides) divided by the calculated current, would give the transistor resistance.

In some exemplary embodiments, the calibration process is performed for transistors connecting each one of the capacitors, so as to allow for current measurement on all capacitor connection options. Additionally, calibration on a subset or even one of the capacitor options can be done by assuming currents on all capacitor connections are similar.

The present disclosed subject matter can be a system, a method, and/or a computer program product. The computer program product may include a computer readable storage medium (or media) having computer readable program instructions thereon for causing a processor to carry out aspects of the present disclosed subject matter.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosed subject matter may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosed subject matter.

Aspects of the present disclosed subject matter are described herein with reference to flowchart illustrations and/or block diagrams of methods, apparatus (systems), and computer program products according to embodiments of the disclosed subject matter. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the FIGURES illustrate the architecture, functionality, and operation of possible implementations of systems, methods, and computer program products according to various embodiments of the present disclosed subject matter. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the FIGURES. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The terminology used herein is for the purpose of describing particular embodiments only and is not intended to be limiting of the disclosed subject matter. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present disclosed subject matter has been presented for purposes of illustration and description, but is not intended to be exhaustive or limited to the disclosed subject matter in the form disclosed. Many modifications and variations will be apparent to those of ordinary skill in the art without departing from the scope and spirit of the disclosed subject matter. The embodiment was chosen and described in order to best explain the principles of the disclosed subject matter and the practical application, and to enable others of ordinary skill in the art to understand the disclosed subject matter for various embodiments with various modifications as are suited to the particular use contemplated.

1. A voltage regulator for regulating power obtained from a bridge of a receiver for powering a load, wherein the receiver is wirelessly charged by a transmitter, the regulator comprising:
a plurality of capacitors connected to each other in series and parallel to a rectified voltage of the bridge;
one selector per one capacitor of the plurality of capacitors for engaging the one capacitor to the load; and
a controller comprising:
one selecting signal per the one selector configured to either engage or disengage the one capacitor to or from the load; and
at least one sensor for current and voltage measurements.

2. The regulator of claim 2, wherein the receiver is integrated within a device and wherein the load is selected from a group consisting of: a battery of a device; the device; and a combination thereof.

3. The regulator of claim 1, wherein the bridge is selected from a group consisting of a full wave rectification circuit; a half wave rectification circuit; and a combination thereof.

4. The regulator of claim 1, wherein the selector is comprised of at least two N-channel Metal Oxide Semiconductor Field Effect Transistor (N-MOS FETs).

5. The regulator of claim 4, wherein the selecting signal is configured to control a gate of the at least two N-MOS FETs in order to engage or disengage the one capacitor to or from the load.

6. The regulator of claim 1, wherein said engaging the one capacitor to the load is performed by the selector for both ends of the capacitor discretely yet concurrently.

7. The regulator of claim 1, wherein voltage across each capacitor of the plurality of capacitors is identical and wherein each capacitor is engaged, by the controller, to the load until voltage measured across the load, by the at least one sensor, drops below a minimum threshold value.

8. The regulator of claim 7, wherein the controller is configured to calculate and set the threshold based on measurements of the rectified voltage and voltage across the load using the at least one sensor.

9. The regulator of claim 1, further comprises dedicated circuit utilized by the controller for continues or periodic current measurements trough the one capacitor.

10. The regulator of claim 1, wherein the controller prevents the plurality of capacitors from engaging to the load for a deadtime occurring between disengaging a capacitor and engaging another capacitor.

11. The regulator of claim 1, wherein the controller utilizes a predetermined switching frequency for engaging and disengaging each capacitor of the plurality of capacitors.

12. The regulator of claim 1, wherein voltage across each capacitor of the plurality of capacitors is identical and wherein at least two capacitors are engaged, by the controller, to the load until voltage measured across the load by the sensor drops below a minimum threshold value.

13. The regulator of claim 1, wherein the controller communicates a request to the transmitter to adjust its transmitted power level to satisfy a desired rectified voltage level.

14. The regulator of claim 1, further comprises at least one additional selector and at least one resistor configured for measuring a voltage drop on the one selector for determining, by the controller, a calibration ratio.

15. The regulator of claim 14, wherein the controller determines the calibration ratio based on the selector resistance obtained by measuring voltage across the selector and calculating current flowing through the selector.

16. A voltage regulator for regulating power obtained from a bridge of a receiver for powering a load, wherein the receiver is wirelessly charged by a transmitter, the regulator comprising:
a plurality of capacitors connected to each other in series and parallel to a rectified voltage of the bridge;
one selector per one capacitor of the plurality of capacitors for engaging the one capacitor to the load; and
a controller comprising:
one selecting signal per the one selector configured to either engage or disengage the one capacitor to or from the load;
at least one sensor for current and voltage measurements; and
wherein the controller communicates a request to the transmitter to adjust its transmitted power level to satisfy a desired rectified voltage level.
